(19) United States
(12) Patent Application Publication
(10) Pub. No.: US 2012/0122387 A1
(43) Pub. Date: May 17, 2012

(54) Air Outlet For Vehicle Applications

(75) Inventors: Kirk NICOLA, Beverly Hills, MI (US); Daniel BOSOC, West Bloomfield, MI (US)

(73) Assignee: International Automotive Components Group North America, Inc., Dearborn, MI (US)

(21) Appl. No.: 12/948,243

(22) Filed: Nov. 17, 2010

(51) Int. Cl. B60H 1/34

(52) U.S. Cl. 454/155

(57) ABSTRACT

An air outlet for directing and regulating air flow within the interior of vehicles is provided, the outlet preferably having 360° adjustability and a relatively uniform rotational effort. The outlet may comprise a plurality of louvers, a linkage, a louver ring and a bezel which mechanically fit together and further includes a spring which is inserted between the louver ring and the bezel which may compensate for tolerance build variations amongst the various components and provide the desired level and range of rotational resistance.

### FIELD

The present disclosure relates generally to air directing and regulating systems in vehicles and, more particularly, to relatively round air duct outlets having a uniform operating effort by imposing a relatively constant stress on a rotating component of the air outlet, wherein the rotating component may regulate the direction and volume of air flow.

### BACKGROUND

Conventionally, vehicle interiors are provided with one or more air duct outlets which are connected by ducts to an outside air source and/or to a cooling and/or heating system that provides cooled and/or heated air to the vicinity of the occupants. Because it is generally desirable for vehicle occupants to be able to adjust the direction of air flow within a vehicle interior, air duct outlets are typically provided with adjustable louvers. In addition, air duct outlets may be provided with dampers for allowing vehicle occupants to control the amount of air flowing there through.

Such outlets for air flow may be located, for instance, in the headliner, door panels, pillars, console and instrument panel of the vehicles. Such outlets may also be found in trucks, boats, planes and even trains.

Various types and shapes of air duct outlets may be provided depending upon special functions, the ability to direct air to various locations and design (theme) constraints within the vehicle. See, for example, U.S. Pat. Nos. 4,345,510; 4,702,156; and 4,006,673.

Vehicle manufacturers continue to seek components, such as air duct outlets, that have enhanced functionality and durability, yet are cost effective to manufacture. Vehicle manufacturers also continue to seek components, such as air duct outlets, that can enhance styling within a vehicle, yet remain functional and economical. This may include air outlets having curved as opposed to relatively straight feature lines.

Air outlets, such as those used in motor vehicles, may generally be rather complex assemblies of louvers, vanes and related linkages which interact to allow the flow of air to be directed and regulated as desired by the vehicle occupants. Such direction of air may be in a generally horizontal or vertical plane as most outlets, or registers, are rectangular in shape. Accordingly, the adjustment of flow may only be possible along the major planes of the outlet shape. Such complex assemblies may have numerous moving parts and complicate the manufacturing and assembly processes, making the outlets expensive to produce and challenging the management of tolerance stack-up between the many interacting subcomponents. This may in turn result in less than satisfactory mechanical reliability and higher than desired operating efforts due to binding of the linkages.

What is needed is an air outlet that is capable of 360° adjustment so that the air may be directed wherever desired, that is relatively quiet in operation and one that provides minimal resistance to air flow. In addition, there is on-going need for an air-outlet that may be adjusted with a consistent and relatively uniform effort, and one that provides a relatively constant resistance to a manual input adjustment that may involve the rotation of a component of the air outlet device.

### SUMMARY

The present invention relates to an air outlet comprising a bezel having an inner periphery and a thrust rib and a ring having an outer periphery, the ring engageable within the bezel inner periphery and rotatable therein. One may then supply a spring having ends and a length, wherein the spring is secured to the bezel inner periphery at its ends, the spring in contact with the outer periphery of the ring along at least a portion of the spring length and wherein the spring biases the ring against the thrust rib.

In another embodiment the present invention relates to a method for adjusting the relative position of an inner ring within an outer ring, wherein the inner ring rotates within the outer ring comprising providing the inner ring, the inner ring including an outer periphery. This may then be followed by providing the outer ring, the outer ring including an inner periphery and providing a spring which at least partially conforms to the outer periphery of the inner ring and the inner periphery of the outer ring. This may then be followed by inserting the spring between the outer periphery of the inner ring and the inner periphery of the outer ring to force at least a portion of the outer periphery of the inner ring against the inner periphery of the outer ring.

### BRIEF DESCRIPTION OF THE DRAWINGS

The features, operation and advantages of the invention may be better understood from the following detailed description of the preferred embodiments taken in conjunction with the attached drawings, in which

FIG. 1 is a perspective view of the air outlet of the present disclosure, partially open;

FIG. 2 is an exploded perspective view of the back of the air outlet of FIG. 1;

FIG. 3 is a rear view of the bezel of the air outlet of FIG. 1; and

FIG. 4 is a rear view of the assembled air outlet of FIG. 1.

### DETAILED DESCRIPTION

Still other objects and advantages of the present invention will become readily apparent to those skilled in the art from the following detailed description, wherein it is shown and described preferred embodiments of the invention. As will be realized the invention is capable of other and different embodiments, and its several details are capable of modification in various respects, without departing from the invention. Accordingly, the description is to be regarded as illustrative in nature and not as restrictive.

The present disclosure is directed at a generally round air outlet for directing and regulating air flow, particularly within vehicles. Reference to round may be understood as not having any periphery that is otherwise planar. Air outlets having a generally rounded shape may provide relatively quieter functioning due to less turbulent air flow as the inner surfaces are generally curved and the overall shape of the outlet may more closely resemble the shape of the duct work that feeds air to the outlet. Similarly, air outlets having a generally rounded shape may offer less resistance to air flow as there may be a smaller transition in cross-section from duct to outlet and a relatively simpler mechanism may be required to direct the air flow.

Most air outlets have generally rectangular shapes and such rectangular shapes may produce more air noise and air flow resistance than round or generally circular shaped outlets. In addition, due to the complexity of multiple louvers and multiple sets of vanes and associated linkages, the efforts to adjust the overall direction of the air flow may become somewhat greater than what may be acceptable for advanced performance.

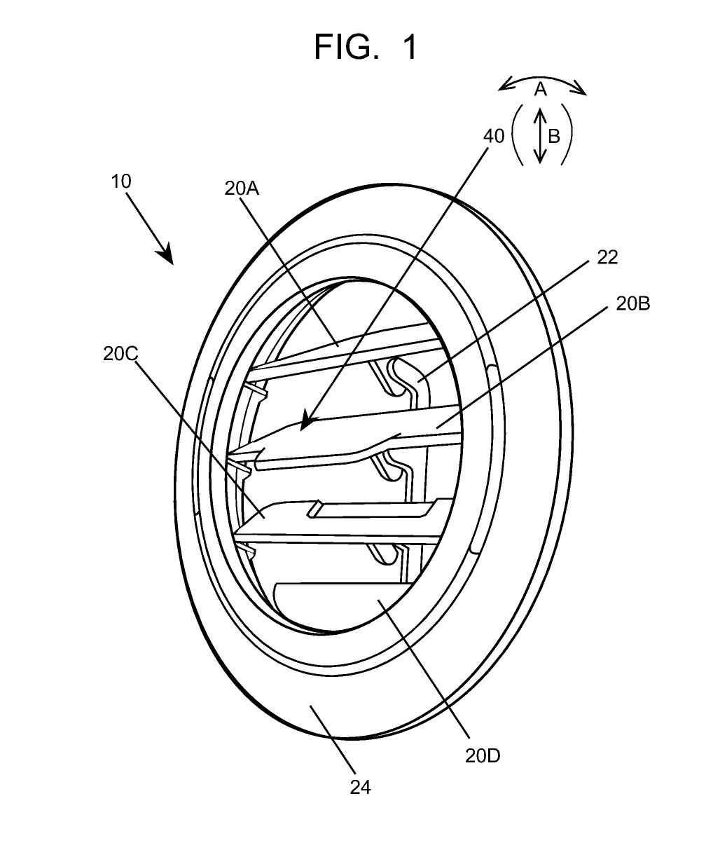

The generally round air outlet of the present disclosure may only require louver adjustment in a single plane, and that plane may be rotatable over the full 360° range of the outlet. FIG. 1 is a perspective view of an exemplary embodiment of the air outlet 10 of the present disclosure if a fully assembled configuration.

In FIG. 1, a bezel 24 surrounds a plurality of louvers 20A, 20B, 20C 20D which are adjustable (shown as partially open) by a flow director 40 which may be integrally molded into one of the louvers 20B. Moving the flow director 40 in the plane of arrow B allows the flow of air to be directionally adjusted and regulated from an open position to a closed position. Linkage 22 may interconnect the louvers, in this case 20A, 20B, 20C 20D such that they operate in unison.

Additionally, flow director 40 may be rotated (arrow A) to allow the flow of air emanating from the outlet 10 to be directed at any angle around the 360° periphery of the outlet 10. Accordingly, one may rotate the flow director 40 to any desired position and allow the flow director to remain at such position under a different position is desired.

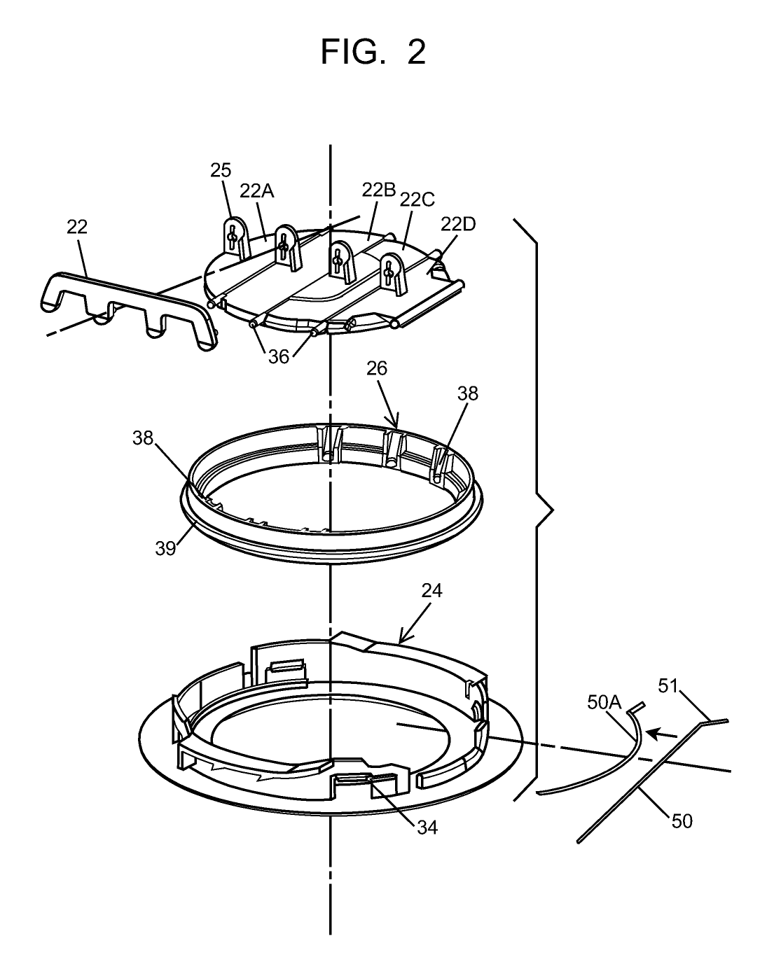

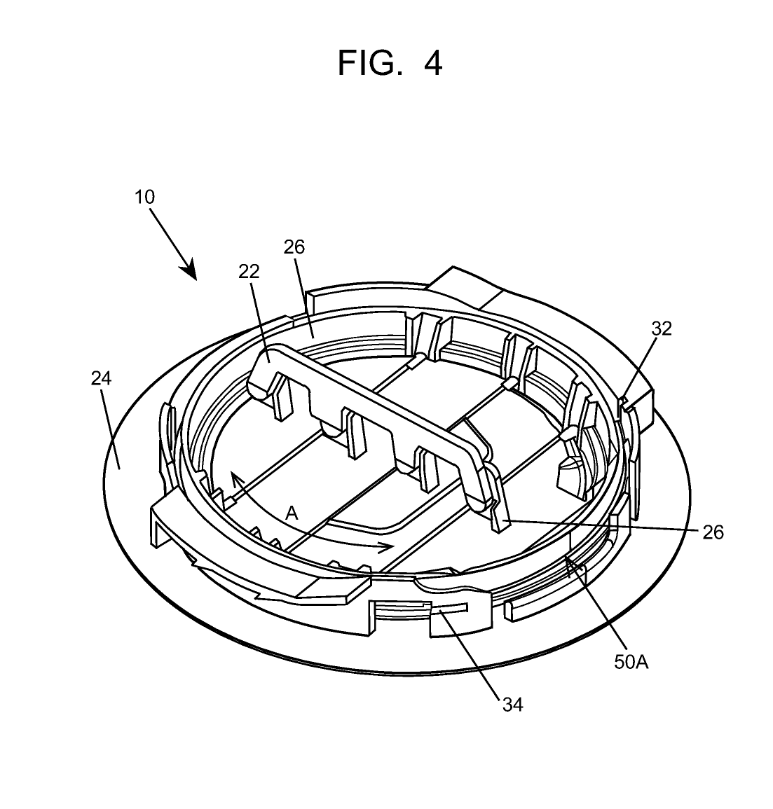

FIG. 2 is an exploded view of the air outlet 10 from the rear, illustrating the components that interact to form the air outlet. The four louvers 20A, 20B, 20C 20D may each include an integrally formed hinge pin 36 which the louvers may swivel upon and which locate the louvers to the louver ring 26 (see FIG. 4). It is contemplated that more or less than 4 louvers may be utilized. For example, one may utilize 2-10 louvers depending upon the overall size of the air outlet. On the back of each louver there may be a connector 25 which engages the louver linkage 22 to allow the louvers to operate in unison when actuated by the movement of the flow director 40 (not shown). In addition, it may be understood that reference to ring herein may be understood as any enclosed structure that fits within a bezel and which may rotate relative to the bezel.

The plurality of louvers 20A, 20B, 20C 20D and the linkage 22 may be assembled together and attached to a louver ring 26 preferably by mechanical snap or friction fit. Other means of mechanical attachment may also be utilized. The louver ring 26 may include at its' inner periphery a number of detents 38 which correspond to the hinge pins 36 and position and secure the louver assembly within the louver ring 26. The detents 38, as shown, may have an inverted keyhole shape.

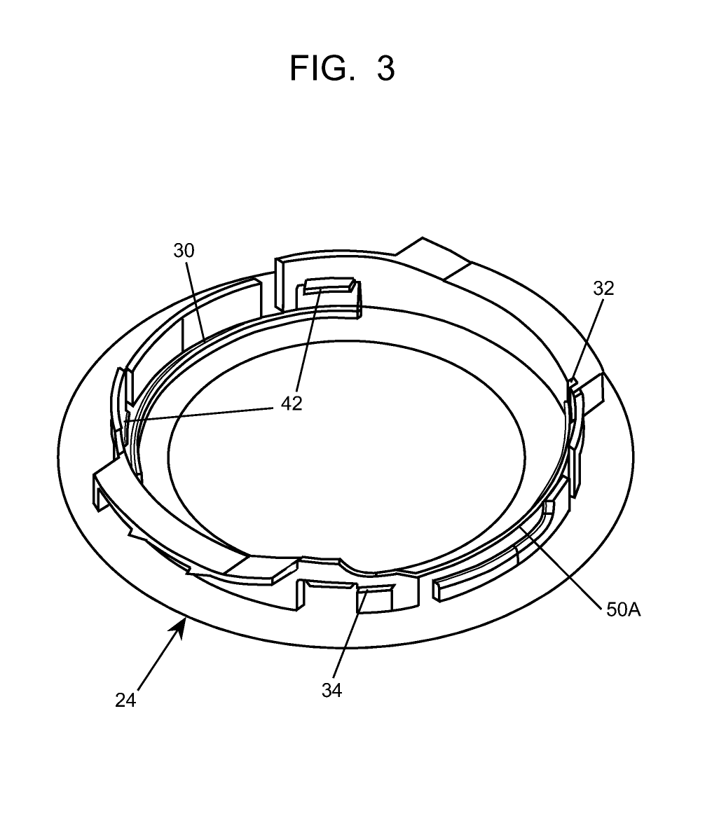

Similarly, once the plurality of louvers, including the linkage, and the louver ring are assembled together, that assembly may be mechanically engaged, by a snap or friction fit, into the rear of the bezel 24 by engaging the outer edge 39 of the louver ring 26 with one or more detent flanges 42 which may reside around the inner periphery of the bezel 24, as shown in FIG. 3.

The various components, louvers, linkages, rings, etc. may be injection molded from a variety of plastics having relatively good dimensional stability, such as polycarbonate (PC), acrylonitrile-styrene-butadiene (ABS), polyamide, polyimide, aramid, liquid crystal polymer, oriented polyethylene, polypropylene, polyphenylene ether polymer and polystyrene as well as blends thereof and glass-filled versions thereof. Plastics herein may therefore be understood as various resins having molecular weights in excess of 10,000 that include identifiable repeating unit structure.

It should be noted that the assembly of molded components herein may present a challenge in adequately controlling the dimensions of each of the components and in managing the tolerance stack-up between mating components so that the efforts required to operate the air outlet are preferably low and uniformly consistent. Such factors as temperature, humidity, moisture content of the plastic resin and tool wear may provide a range of dimensions of the components. Further, variations in the conditions of assembly and in the use within the vehicle may add further dimensional variation. The result may be an air outlet that is relatively difficult to adjust under some conditions, and which may not remain sealed under other conditions of use.

To address this issue, the air outlet 10 of the present disclosure may preferably include a spring 50 which may be inserted into the space between the outer periphery of the louver ring 26 and the inner periphery of the bezel 24 to act as a compression device to provide uniform and consistent efforts for operating (opening, closing and rotating the louvers) the outlet 10. That is, the placement of the spring provides a relatively constant stress on the louver ring 26 which acts as a rotating component to regulate the direction and volume of air flow. In addition, by imposing a relatively constant stress as noted the problems noted herein with regards to the size of the components when assembled and engaged to one another, are effectively reduced while simultaneously providing to the user a relatively constant resistance to any repositioning effort. Accordingly, when rotating the louver ring 26 herein, it is contemplated that the resistance to such rotation will be within +/−25.0% of the average resistance that is present. Resistance may be measured in units of torque (lb.-inches or Ncm). In terms of units of torque resistance, preferably, the torque resistance is in the range of 2-15 Ncm.

The spring 50 in a first configuration may preferably be a relatively straight longitudinal element comprising metal or plastic having a relatively high yield strength and resilience.

The spring 50 may include a hook feature 51 on one or both ends for handling and securing the spring into slots between the outer periphery of the louver ring 26 and the inner periphery of the bezel 24. The spring 50 may be flexed into a stressed and curved configuration 50A by securing the one end into slot 32 and threading the spring, using force to flex it, between the outer periphery of the louver ring 26 and the inner periphery of the bezel 24 and engaging an end in slot 34 in the bezel 24, as shown in FIG. 3. When the louver ring 26 is assembled into the back side of the bezel 24, the spring 50A biases the louver ring 26 against the thrust rib 30 (FIG. 3) and acts much like a leaf spring by having its' ends secured and applying compression against the louver ring 26. The thrust rib may therefore be understood as any structure that provides resistance to the biasing imposed upon it by the spring. This then may provide a force to locate the louver ring 26 within the bezel 24 which may vary according to the relative position or dimensions of the outer periphery of the louver ring 26 and the inner periphery of the bezel 24, thus providing a relatively uniform and consistent rotational effort for operating the louvers. For instance, if one of the rings is out-of-round compared to the mating ring, the spring may act to compensate and shift the inner ring to provide a consistent fit. Stated another way, the rings of the outlet of the present disclosure may not have to be perfectly round, one to the other, to provide an acceptable range of rotational efforts.

Preferably, the spring 50 may comprise a metallic material such as a low alloy, medium carbon steel, high carbon steel or stainless steel with relatively high yield strength. This may allow the spring to return to its' original shape despite significant flexing or twisting. An example of such a spring steel is AISI 9255 (DIN and UNI: 55Si7, AFNOR 55S7). The spring steel may be hardened and tempered to about 45 Rockwell C. Preferably, the spring comprises “music wire” per ASTM A228 and has yield strength in the range of 200,000-400,000 psi. Plastic materials such as acetal, PBT, liquid crystal polymer, aramid, polyetherimide and oriented polyethylene may also function as the spring 50.

The spring 50 may have a cross-section that is uniform and circular, elliptical, flat or multi-sided (for instance from 3 to as many as 12 sides). It may have a length that is between about 10% to about 50% of the inner circumference of the bezel 24. In one exemplary embodiment the length was about 3 inches and the diameter was 0.015 inches for an outlet having an effective area of about 4-5 square inches. For such an air outlet, the air flow is 40-80 cfm.

It is contemplated that one or more of the yield strength, the length and the diameter or cross-section of the spring may be varied to provide different levels and ranges of rotational effort when articulating the outlet.

The spring 50, and/or the mating surfaces of the louver ring and bezel, may be coated to enhance the operation of the outlet and provide even further reductions in the rotational effort. Such coatings may comprise relatively low friction materials, such as, silicone, molybdenum disulphide and fluorinated polymers such as Teflon®. Reference to relatively low friction material may be understood as a material that reduces the coefficient of friction that would otherwise be present between the surface of the ring which ring surface engages with the spring.

FIG. 4 illustrates the back side of the air outlet 10 in a fully assembled and closed configuration with the spring 50A in place. Arrow A indicates the rotational operation of the louvers and louver ring.

The air outlet 10 of the present disclosure may find particular use within a trim component of a vehicle. A trim component may be understood as any component utilized in the interior of the vehicle, and which are visible to an occupant. Trim components may therefore include overhead systems in vehicles, such as in headliners and consoles. Trim component may also include instrument panels, door panels, wheel-well panels, flooring, trunk liners, pillar cover panels, close-out panels, etc.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. An air outlet comprising:
a bezel having an inner periphery and a thrust rib;
a ring having an outer periphery, said ring engageable within said bezel inner periphery and rotatable therein;
a spring having ends and a length, said spring is secured to said bezel inner periphery at said ends, said spring in contact with said outer periphery of said ring along at least a portion of said length,
wherein said spring biases said ring against said thrust rib.

2. The air outlet of claim 1 wherein said spring biases said ring against said thrust rib to provide an average resistance to rotation, and wherein said resistance to said rotation is within +/−25.0% of said average resistance.

3. The air outlet of claim 1 wherein said ring and said bezel are round.

4. The air outlet of claim 1 wherein said spring prior to placement in said air outlet is a relatively straight longitudinal element.

5. The air outlet of claim 1 wherein said spring comprises a metallic material with a yield strength of greater than 200,000 psi.

6. The air outlet of claim 1 wherein said spring comprises plastic.

7. The air outlet of claim 1 wherein said ring rotates 360°'s relative to said bezel ring.

8. The air outlet of claim 1 wherein said ring includes a plurality of louvers including a linkage.

9. The air outlet of claim 8 wherein one of said plurality of louvers includes a flow director.

10. The air outlet of claim 8 wherein said louvers, said linkage, said bezel and said ring mechanically engage one another.

11. The air outlet of claim 1 wherein said ring has a surface and said spring is coated with a material which reduces the coefficient of friction as between said ring and said spring.

12. The air outlet of claim 1 wherein said air outlet is positioned in a trim component within the interior of a vehicle.

13. The air outlet of claim 12 wherein said trim component comprises one of a headliner, a door panel, a pillar, a console, an instrument panel or an overhead system.

14. The air outlet of claim 1 wherein said the length of said spring is between about 10% and 50% of the inner periphery of the bezel.

15. A method for adjusting the relative position of an inner ring within an outer ring, wherein said inner ring rotates within said outer ring, comprising:
providing said inner ring, said inner ring including an outer periphery;
providing said outer ring, said outer ring including an inner periphery;
providing a spring which at least partially conforms to said outer periphery of said inner ring and to said inner periphery of said outer ring;
inserting said spring between said outer periphery of said inner ring and said inner periphery of said outer ring to force at least a portion of said outer periphery of said inner ring against said inner periphery of said outer ring.

16. The method of claim 15 wherein said spring comprises a low alloy, medium carbon steel, high carbon steel or stainless steel with a yield strength of greater than 200,000 psi.

17. The method of claim 15 wherein said inner ring rotates 360°'s relative to said outer ring.

18. The method of claim 15 wherein said spring is coated with a material which reduces the coefficient of friction as between said ring and said spring.

19. The method of claim 15 wherein said outer ring is a bezel for an air outlet and said inner ring includes a plurality of louvers for directing and regulating air flow.

20. The method of claim 15 wherein the spring has a diameter, and a length and a yield strength and one or more of said diameter, length and yield strength is varied to vary said force.

21. An air outlet comprising:
a bezel having an inner periphery and a thrust rib;
a ring having an outer periphery, said ring engageable within said bezel inner periphery and rotatable therein;
a metallic spring having ends and a length, said spring is secured to said bezel inner periphery at said ends, said spring in contact with said outer periphery of said ring along at least a portion of said length;
wherein said spring biases said ring against said thrust rib to provide an average resistance to rotation, and wherein said resistance to said rotation is within +/−25.0% of said average resistance.
